(19) United States
(12) Patent Application Publication
(10) Pub. No.: US 2008/0193822 A1
(43) Pub. Date: Aug. 14, 2008

(54) Proton conducting membrane of polymer blend and process for preparing poly(amide imide) used therein

(75) Inventors: Chen-Chi Martin Ma, Hsinchu (TW); Han-Lang Wu, Hsinchu (TW); Tzong-Ming Lee, Hsinchu (TW); Yu-Feng Lin, Hsinchu (TW); Chia-Hsun Lee, Hsinchu (TW)

Correspondence Address: BACON & THOMAS, PLLC, 625 SLATERS LANE, FOURTH FLOOR, ALEXANDRIA, VA, 22314, US

(73) Assignee: National Tsing Hua University, Hsinchu (TW)

(21) Appl. No.: 12/010,127

(22) Filed: Jan. 22, 2008

(30) Foreign Application Priority Data
Jan. 30, 2007 (TW) 96103423

(51) Int. Cl. H01M 8/10

(52) U.S. Cl. 429/33

(57) ABSTRACT

The present invention discloses a polymer blend of sulfonated polymer such as poly(ether ether ketone) and poly(amide imide) for use as an proton-conducting membrane. The poly(amide imide) is prepared by conducing a ring-opening and condensation reactions of diisocyanate and 1,2,4-benzenetricarboxylic anhydride (TMA). The polymer blend has a reduced methanol uptake and methanol permeability while maintaining good proton conductivity, and thus is suitable for use as a proton-conducting membrane of a fuel cell. The present invention also discloses a process for preparing the poly(amide imide).

### FIELD OF THE INVENTION

The present invention is related to a proton-conducting membrane for use in a direct methanol fuel cell, and a process of preparation the same. The proton-conducting membrane of the present invention contains a polymer matrix of sulfonated poly(ether ether ketone) ((hereinafter abbreviated as PEEK) which is further blended with poly(amide imide).

### BACKGROUND OF THE INVENTION

U.S. Pat. No. 6,355,149 discloses an environmentally compatible and low cost proton-conducting membrane based on poly(ether ether ketone), which demonstrates good mechanical properties and process ability with a sulfonated poly(ether ether ketone) having a molecular weight of 100,000 to 240,000. The durability test shows the proton-conducting membrane prepared in this US patent has an operation time longer than 3000 hours with a proton conductivity greater than 0.02 S cm⁻¹.

U.S. Pat. No. 5,795,496 discloses proton conducting membranes which are formed based on a sulfonic acid-containing polymer. One preferred material is poly(ether ether ketone). Another is poly(p-phenylene ether sulfone). This material is further processed in a way to minimize the methanol permeability. One preferred aspect modifies the surface to produce asymmetric permeability properties by controlled cross-linking of sulfonate groups at 120° C. and vacuum pressure. The proton conductivity is attained by controlling the degree of sulfonation.

U.S. Pat. No. 6,248,469 discloses a composite solid polymer electrolyte membranes (SPEMs) which include a porous polymer substrate interpenetrated with an ion-conducting material such as Nafion®, sulfonated PEEK and sulfonated polyether sulfone. The pore size of the porous polymer ranges from 0.01 to 20 microns. In comparison with Nafion® 117, the SPEMs prepared in this US patent have a lower methanol permeability less than 50 mA/cm², and have an Ion-exchange capacity of 1.5 to 2.0 (meq/g dry SPE).

The proton-conducting membrane is one of the core elements in the fuel cell. A high performance proton-conducting membrane requires the following conditions: (1) high proton conductivity, (2) low electron conductivity, (3) low fuel permeability and oxide permeability, (4) low water drag during proton conduction, (5) ability to resist oxidation and hydrolysis, (6) good mechanical properties, (7) low cost, (8) good adhesion to catalyst and low interfacial resistivity. Nafion® and other proton-conducting perfluoro membranes have rather good performance at a temperature lower than 90° C. and humid condition. However, they suffer high manufacturing cost and poor barrier ability to methanol solution. Alternative polymeric materials for use as a proton-conducting membrane have been developed such as poly(arylene ethers), polyimide and poly(phosphazene), which are subjected to sulfonation to enhance their proton conductivity.

The lifetime of sulfonated poly(ether ether ketone) (hereinafter abbreviated as SPEEK can reach 3000 hours or even longer, and it thus has a great potential to be commercialized. The proton conductivity of SPEEK is enhanced as its degree of sulfonation is increased, while significantly increasing the swellabilty of SPEEK to water or a solvent. In order to minimize the degree of swelling of SPEEK, approaches have been proposed by many researchers such as blending SPEEK with poly(ether sulfone) (PES) [Journal of Membrane Science 199 (2002) 167-176], poly(ether imide) (PEI) [Journal of Polymer Science Part B: Polymer Physics 38 (2000) 1386-1395], or polyvinylpyrrolidone (PVP) [Journal of Polymer Science Part B: Polymer Physics 44 (2006) 565-572]. Blending SPEEK with these hydrophobic polymers can reduce the solvent absorbance and bar methanol permeance.

### SUMMARY OF THE INVENTION

A primary objective of the present invention is to provide a proton-conducting membrane of fuel cell having a high proton conductivity, low swellability, good mechanical properties, and high thermal stability.

A proton-conducting membrane for use in a fuel cell prepared in accordance with the present invention is a polymer blend, and said polymer blend comprises 50-99 wt % of a sulfonated polymer and 1-50 wt % of poly(amide imide), wherein said sulfonated polymer is selected from the group consisting of sulfonated poly(ether ether ketone), sulfonated poly(ether ketone), sulfonated poly(ether ketone ketone) and sulfonated poly(ether sulfone), and said poly(amide imide) has a weight average molecular weight of 10,000 to 500,000, and a repeating unit represented by the following structure:

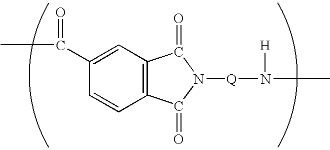

wherein Q is arylene.

Preferably, said polymer blend has 20-40 wt % of poly(amide imide).

Preferably, Q in the structure is phenylene, methylphenylene, naphthylene or

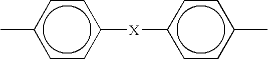

wherein X is

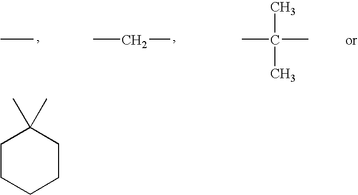

More preferably, Q is

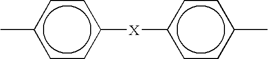

wherein X is methylene.

Preferably, said sulfonated polymer is sulfonated poly(ether ether ketone). More preferably, said sulfonated poly(ether ether ketone) has a weight average molecular weight of 20,000 to 300,000.

Preferably, said sulfonated poly(ether ether ketone) has an ion exchange equivalent of 1.0 to 2.5 mili-equivalent/gram.

The present invention also discloses a process for preparing the poly(amide imide) recited in claim 1 comprising carrying out a ring-opening and condensation reaction between 1,2,4-benzenetricarboxylic anhydride and a diisocyanate having the following formula in a solvent at a temperature of 60-150° C. for a period of 1 to 8 hours:

O═C═N-Q-N═C═O

wherein Q is defined as above.

Preferably, the reaction is carried out at 110-130° C. for a period of 4 to 6 hours.

### BRIEF DESCRIPTION OF THE DRAWING

FIG. 1 shows the methanol permeability (round dot) and proton conductivity (blank square) of the SPEEK/PAI membrane prepared in Example of the present invention (SPEEK composition: 90 wt %, 80 wt %, 70 wt % and 60 wt %), the SPEEK membrane prepared in Control Example (SPEEK composition: 100 wt %) and the Nafion® 117 membrane.

### DETAILED DESCRIPTION OF THE INVENTION

In the present invention poly(amide imide) (hereinafter abbreviated as PAI) is used to reduce the degree of swelling and methanol permeability of a sulfonated PEEK.

A suitable process for preparing a polymer blend of the present invention includes dissolving a sulfonated polymer in a first organic solvent, dissolving PAI in a second organic solvent, and mixing the resulting solution of the sulfonated polymer and the resulting solution of the PAI to form a solution of polymer blend.

Suitable organic solvents for use as the first organic solvent include (but not limited thereto) N-methyl-2-pyrrolidone (abbreviated as NMP), N,N-dimethylacetamide (abbreviated as DMAc), dimethylformamide (abbreviated as DMF), and dimethylsulfoxide (abbreviated as DMSO).

Suitable organic solvents for use as the second organic solvent include (but not limited thereto) NMP, DMAc, DMF, DMSO, pyridine, and methyl pyridine.

A suitable process for preparing a proton-conducting membrane of the present invention includes coating the solution of polymer blend prepared above on a substrate, and removing solvent(s) from the resulting coating by evaporating at a temperature of 40-150° C. and a pressure of vacuum to one atm, thereby a proton-conducting membrane is formed. Preferably, the evaporating is conducted by heating at a temperature of 40-90° C. for 12-24 hours to remove most of the solvent(s), and heating at a temperature of 110-120° C. for two days to remove the remaining solvent(s).

The sulfonated polymer used in the present invention is prepared by sulfonating a polymer which may be selected from the group consisting of poly(ether ether ketone), poly(ether ketone), poly(ether ketone ketone) and poly(ether sulfone). The sulfonation is carried out by reacting the polymer with a sulfonating agent. A suitable sulfonating agent is, for examples oleum, concentrated sulfuric acid, concentrated sulfonic acid, sulfur trioxide, alkanesulfonic acid and (trimethylsilylsulfonyl chloride). The sulfonated poly(ether ether ketone), sulfonated poly(ether ketone), sulfonated poly(ether ketone ketone) and sulfonated poly(ether sulfone) have been used as a proton-conducting membrane in a direct methanol fuel cell (abbreviated as DMFC) in the prior art, for examples in the above-mentioned U.S. Pat. No. 6,355,149 and U.S. Pat. No. 5,795,496, the disclosures of which are incorporated herein by reference.

The poly(amide imide) used in the present invention has a repeating unit which can be represented by the following formula:

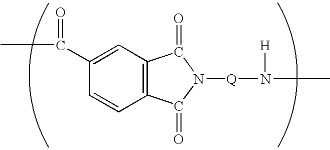

wherein Q is arylene.

A suitable process for preparing the aforesaid poly(amide imide) comprises carrying out a ring-opening and condensation reaction between 1,2,4-benzenetricarboxylic anhydride (abbreviated as TMA) and a diisocyanate in a solvent at a temperature of 60-150° C. for a period of 1 to 8 hours, and preferably at 110-130° C. for a period of 4 to 6 hours.

The present invention will be better understood through the following examples which are merely for illustrative purpose, not for limiting the scope of the present invention.

### EXAMPLE

To a concentrated sulfuric acid at 40° C. poly(ether ether ketone) available from Victrex plc. (Victrex® 450 PF) was added, and a sulfonation reaction was conducted therein by continuously stirring for 7 to 10 hours. Upon completion of the sulfonation reaction the reaction mixture was pour into a pool of ice water to precipitate the sulfonated polymer, which was then removed therefrom and washed with water several times until the pH value of spent water greater than 6. The washed polymer was dried at 80° C. and milled to powder. The sulfonated poly(ether ether ketone) (SPEEK) in powder form was then dissolved in NMP solvent, which was then filtered to remove SPEEK having a low degree of sulfonation, thereby a NMP solution of SPEEK was obtained.

Poly(amide imide) (PAI) was synthesized, and the reaction involved was shown as follows:

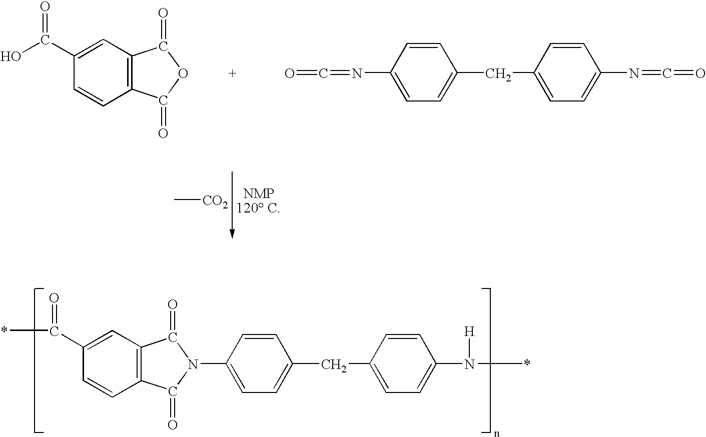

Into a three-neck round-bottom glass flask of 500 ml 250 g (1 mole) methylene diparaphenylene isocyanate (abbreviated as MDI) and 192 g (1 mole) 1,2,4-benzenetricarboxylic anhydride (abbreviated as TMA) were added, followed by adding 400 g of N-methyl-2-pyrrolidinone (abbreviated as NMP) as a solvent. The reaction solution in the flask was mechanically agitated from room temperature to 120° C. by heating. At the beginning the reaction solution was pale yellow and opaque, which became transparent at 50° C. and started bubbling (CO₂). The bubbling became vigorous at 120° C. and the temperature in the flask would increase due to generation of reaction heat, which was kept at 120° C. by cooling. The reaction was continued until no bubbling was observed, and it took about six hours. The heating was then stopped, and a cooled solution of poly(amide imide) (PAI) was obtained in the flask. A portion of PAI solution was removed from the flask for analysis of chemical structure and solid content. Another portion of PAI solution was also removed from the flask and added into methanol solvent. A precipitate was formed in the methanol solvent, and a yellow-white solid was recovered therefrom by filtration. The yellow-white solid was baked at 200° C. for two hours to obtain poly(amide imide) (PAI).

The resultant poly(amide imide) (PAI) was dissolved in pyridine solvent, and the PAI solution formed was mixed with the NMP solution of SPEEK prepared above in a predetermined weight ratio (SPEEK/PAI 90/10, 80/20, 70/30 and 60/40 w/w). The polymer blend solution after thorough mixing was coated on a glass plate to form a coating layer, which was subjected to 12-hour heating at 90° C. and 1 atm to remove most of solvents, and 2-day heating at 120° C. and vacuum pressure to remove the remaining solvent from the coating layer. Finally, the glass plate was immersed in water at room temperature to facilitate the stripping of a membrane from the glass plate.

### Control Example

Procedures in aforesaid Example were repeated to form a SPEEK membrane, wherein the NMP solution of SPEEK instead of the polymer blend solution was coated on the glass plate.

### Tests:

1. Sulfonation Degree of SPEEK, and Molecular Structure of poly(amide imide)

### Methods:

### a. ¹H Nuclear Magnetic Resonance (¹H-NMR)

¹H-NMR spectra were taken by using a NMR spectrometer available from Bruker BioSpin Co., MA., USA, under the code of DMX-500. The concentrations of the samples ranged from 2-5 wt %, the solvent used was Dimethyl sulfoxide (DMSO-d6), and the scan was run at room temperature for 32 times.

b. Intrinsic Viscosity

The method for measuring the intrinsic viscosity included dissolving 30 mg of a polymer specimen in 30 ml NMP solvent. The solution was kept at 25° C. in a constant temperature water bath, and the viscometer of Cannon Ubbelohde was used to measure the viscosity.

c. Molecular Weight

The molecular weight of a polymer specimen was measured by using Gel permeation chromatography (GPC), Waters 510 isocratic HPLC pump and Waters 2410 refractive index detector. Polystyrene was used as standards. There chromatography columns were use, which were Styragel HR 0.5, 4 and 5, respectively. The mobile phase was NMP, and the flow rate was 1 ml per minute. The operation temperature was 100° C.

### Results:

Degree of sulfonation (DS) is calculated according to the following formula (1):

$$\frac{DS}{12 - 2 DS} = \frac{{A}_{{H}_{E}}}{\sum {A}_{{H}_{A , {A}^{′} , B , {B}^{′} , C , D}}} 0 \leq n \leq 1 \qquad ( 1 )$$

wherein A is the integral value of a specific signal in NMR spectrum, and DS is degree of sulfonation. The DS of the SPEEK used in Example and Control Example is 64%.

Table 1 lists the intrinsic viscosity, weight-average molecular weight and polydispersity index of the PAI and SPEEK prepared in Example. The number-average molecular weight of the PAI is 26,289 g mol⁻¹.

TABLE 1
Intrinsic viscosity, weight-average molecular weight and
polydispersity index of the PAI and SPEEK

| | DS¹ | [η]² | M_{w}³ | |
|---|---|---|---|---|
| | (%) | (dL g⁻¹) | (g mol⁻¹) | PDI⁴ |
| SPEEK | 64.5 | 4.68 | 256122 | 7.2 |
| PAI | — | 0.55 | 241857 | 9.2 |

¹Degree of sulfonation measured by ¹ H NMR
²Intrinsic viscosity measured by using NMP solvent and at 25° C.
³Molecular weight measured by GPC, wherein NMP was the mobile phase, polystyrene was the standards, and the operation temperature was 100° C.
⁴Polydispersity index.

### 2. Methanol Permeability and Proton Conductivity

### Method for Measuring Methanol Permeability:

Methanol solution (50 vol %) was placed in bottle A, and pure water was placed in bottle B, wherein the bottle A and bottle B was connected to each other with a conduit having a membrane mounted in advance at the center thereof, so that the two liquids was separated by the membrane. The membrane tested was the SPEEK/PAI membrane prepared in Example, the SPEEK membrane prepared in Control Example, and a commercially available proton-conducting membrane, Nafion® 117. The liquids in the bottles A and B were stirred with magnetic stirrers to make sure they are homogenous. The methanol concentration in the bottle B was measured regularly by measuring the refractive index of the liquid and calculating the methanol concentration thereof based on the relationship between the refractive index and the methanol concentration of the methanol solution, which was established by correlating the measured refractive indexes of the methanol solutions having known methanol concentrations and the known methanol concentrations thereof. The methanol permeability is calculated according to the following formula (2):

$${C}_{B} ( t ) = \frac{A}{{V}_{B}} \frac{DS}{L} {C}_{A} ( t - {t}_{0} ) \qquad ( 2 )$$

wherein A, L, V_{B}, C_{B} and C_{A} are effective area, thickness of the membrane, volume of the dilute side, the methanol concentration of the dilute side and the methanol concentration of the concentrated side, respectively; D, S and t₀ represent methanol diffusivity, solubility and starting time, respectively.

### Method for Measuring Proton Conductivity:

Proton conductivity was tested through an electrochemical interface (1260 Interface/gain phase analyzer, Solartron, U.K.). The membrane was clamped between two different Pt electrodes under atmospheric condition, wherein the upper Pt electrode was a Pt wire having radius of 0.5 mm and the lower Pt electrode was a disc having a radius of 0.5 cm. The frequency range was 10 Hz-10 MHz. The clamping force on the proton-conducting membrane was adjusted by a spring means to maintain a constant value for each test.

Prior to the measurement of the proton conductivity, the membrane was immersed in 60° C. water to saturate the membrane. The proton conductivity was calculated by σ=L/RA, wherein σ is the proton conductivity, L is the thickness of the membrane, R is the resistance obtained by measuring AC impedance, and A is the contact area between the membrane and the electrodes.

### Results:

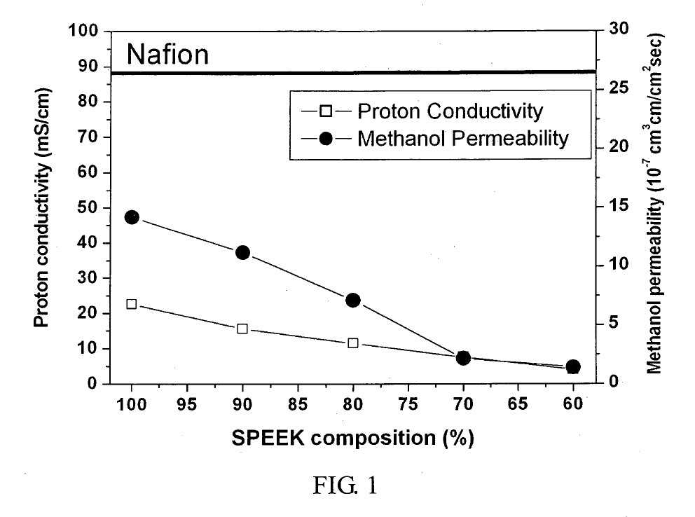

The methanol permeability and proton conductivity of the SPEEK/PAI membrane prepared in Example, the SPEEK membrane prepared in Control Example and the Nafion® 117 membrane are shown in FIG. 1. It can be seen from FIG. 1 that the proton conductivity and the methanol permeability of the SPEEK/PAI membrane of the present invention both decrease as the SPEEK wt % decreases, but the former has a relatively lower decreasing rate. It is a common problem that the proton-conducting membrane for use in a DMFC will have a lower proton conductivity if the methanol permeability thereof is reduced. Therefore, a preferable approach for designing a proton-conducting membrane of DMFC is to observe the selectivity change, which is defined by dividing the proton conductivity with the methanol permeability. The selectivity of the SPEEK/PAI polymer blend membrane (70/30, w/w) of the present invention, the SPEEK membrane of Control Example (100 wt %) and the Nafion® 117 membrane are 4.0×10⁴ S s cm⁻³, 2.1×10⁴ S 5 cm⁻³, and 3.8×10⁴ S 5 cm⁻³, respectively. The SPEEK/PAI SPEEK/PAI polymer blend membrane (70/30, w/w) of the present invention has the highest selectivity and is thus suitable for use as a proton-conducting membrane of DMFC.

### 3. Water Content and Methanol Content

### Measurement Methods:

A membrane to be tested was cut to a size of 2 cm×2 cm, and then was immersed in a solution having a desired concentration at a predetermined temperature for two days. Then, the immersed membrane was removed from the solution, and wiped gentlely with paper to remove the solution on the surfaces thereof, immediately followed by weighting the membrane to obtain a wet membrane weight. The wet membrane was dried in an oven at 80° C. for two hours, and then removed from the oven, followed by weighting the membrane to obtain a dry membrane weight.

Solution content=(wet membrane weight−dry membrane weight)/dry membrane weight×100%

### Results:

The absorption values in water and methanol solutions of the SPEEK/PAI membrane prepared in Example, the SPEEK membrane prepared in Control Example and the Nafion® 117 membrane are shown in Table 2. The water contents of the SPEEK membrane and the SPEEK/PAI membrane at 25° C. and 60° C. are higher than those of the Nafion® 117 membrane; however, the water contents of the SPEEK/PAI polymer blend membrane (60/40, w/w) of the present invention are close to those of the Nafion® 117 membrane, as shown in Table 2. As to the methanol solution, the methanol content of the SPEEK/PAI polymer blend membrane (60/40, w/w) of the present invention is also close to that of the Nafion® 117 membrane when the tested the methanol solution is 10 vol %, as shown in Table 2. In general, the SPEEK/PAI polymer blend membranes have lower water contents and methanol contents in comparison with the SPEEK membrane, i.e. the former have an improved solution swellability.

TABLE 2
The absorption values in water and methanol solutions of the
SPEEK/PAI membrane, the SPEEK membrane and the Nafion ®
117 membrane

| | Water content | | | | |
|---|---|---|---|---|---|
| | (%) | | Methanol content (%) 60° C. | | |
| | 25° C. | 60° C. | 10 vol % | 30 vol % | 50 vol % |
| Nafion ® 117 | 19 | 22 | 26 | 34 | 62 |
| Control Ex. | | | | | |
| SPEEK | 51 | 1128 | N/A | N/A | N/A |
| Example | | | | | |
| SPEEK/PAI | | | | | |
| (w/w) | | | | | |
| 90/10 | 30 | 87 | 1250 | N/A | N/A |
| 80/20 | 26 | 41 | 221 | N/A | N/A |
| 70/30 | 22 | 27 | 46 | 1100 | N/A |
| 60/40 | 19 | 25 | 30 | 389 | 1529 |

N/A: not available

1. A proton-conducting membrane for use in a fuel cell, which is a polymer blend, said polymer blend comprises 50-99 wt % of a sulfonated polymer and 1-50 wt % of poly(amide imide), wherein said sulfonated polymer is selected from the group consisting of sulfonated poly(ether ether ketone), sulfonated poly(ether ketone), sulfonated poly(ether ketone ketone) and sulfonated poly(ether sulfone), and said poly(amide imide) has a weight average molecular weight of 10,000 to 500,000, and a repeating unit represented by the following structure: 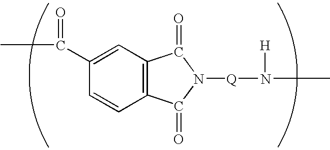
wherein Q is arylene.

2. The proton-conducting membrane of claim 1, wherein said polymer blend has 20-40 wt % of poly(amide imide).

3. The proton-conducting membrane of claim 1, wherein Q is phenylene, methylphenylene, naphthylene or 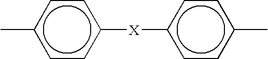
wherein X is

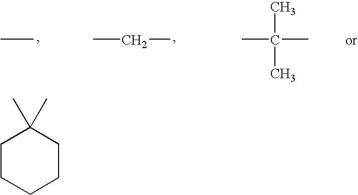

4. The proton-conducting membrane of claim 1, wherein Q is 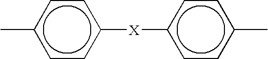
wherein X is methylene.

5. The proton-conducting membrane of claim 1, wherein said sulfonated polymer is sulfonated poly(ether ether ketone).

6. The proton-conducting membrane of claim 5, wherein said sulfonated poly(ether ether ketone) has a weight average molecular weight of 20,000 to 300,000.

7. The proton-conducting membrane of claim 5, wherein said sulfonated poly(ether ether ketone) has an ion exchange equivalent of 1.0 to 2.5 mili-equivalent/gram.

8. A process for preparing the poly(amide imide) recited in claim 1 comprising carrying out a ring-opening and condensation reaction between 1,2,4-benzenetricarboxylic anhydride and a diisocyanate having the following formula in a solvent at a temperature of 60-150° C. for a period of 1 to 8 hours:
O═C═N-Q-N═C═O
wherein Q is defined as in claim 1.

9. The process of claim 8, wherein the reaction is carried out at 110-130° C. for a period of 4 to 6 hours.

10. The process of claim 8, wherein Q is phenylene, methylphenylene, naphthylene or 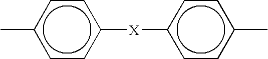
wherein X is

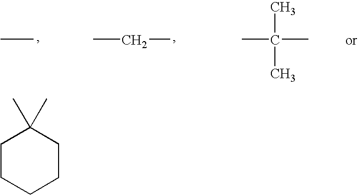

11. The process of claim 8, wherein Q is 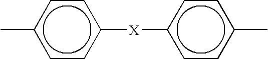
wherein X is methylene.
